(19) United States
(12) Patent Application Publication
(10) Pub. No.: US 2004/0103255 A1
(43) Pub. Date: May 27, 2004

(54) Memory sub-array selection monitoring

(76) Inventor: Warren Kurt Howlett, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/303,937

(22) Filed: Nov. 25, 2002

(51) Int. Cl. G06F 12/00

(52) U.S. Cl. 711/156; 711/167

(57) ABSTRACT

An on-chip monitor is provided for monitoring operations performed on an on-chip memory block. The monitor monitors the sub-array accessed by memory access operations, in addition to other information related to the operation, such as the index of the accessed memory location, the data read from or written to the memory location, and the write enable signal. The monitor circuitry may store monitored data quickly enough to avoid having an impact on normal operation of the memory block. Furthermore, the monitor circuitry may utilize a relatively small number of circuit elements and control signals to enable the monitor to fit within the confines of an on-chip memory. The monitor may include circuitry for reading monitored data in a way that enables the monitored block identifier, index, sub-array identifier, and cache data for each memory operation to be correlated with each other quickly and easily.

### BACKGROUND

1. Field of the Invention

The present invention relates to testing of memory arrays and, more particularly, to techniques for testing and monitoring on-chip memory arrays of an integrated circuit.

2. Related Art

As memory arrays have become faster and smaller, the trend has been to place such high-speed arrays on-chip. Until relatively recently, computer memory was typically located on integrated circuits (ICs) distinct from the central processing unit (CPU) of the computer. Communication between the CPU and separate memory devices was accomplished by porting the inputs and outputs of the memory arrays to package pins of the memory devices to the CPU via address and data busses. As IC fabrication technology has evolved to the sub-micron level, as evidenced by devices fabricated using a 0.25-micron or even smaller fabrication process, it has become possible to place large memory arrays, such as random access memories (RAMs), static random access memories (SRAMs), and cache RAMs, entirely on-chip with other circuitry, such as a CPU. On-chip memory arrays provide the advantage of direct communication with the CPU without the need for I/Os to external pins.

In spite of the advantages of placing memory arrays on-chip, it can be difficult to test on-chip arrays. On-chip memory arrays, which may account for a large portion of the total die area of a chip, are much harder to control and observe than their discrete predecessors, making it difficult to use traditional external tester equipment and hardware to test, screen, characterize, and monitor on-chip arrays. The ability to observe the operation of on-chip memory arrays is severely limited by the placement of the array-chip interface, such as the interface between an on-chip memory array and a CPU core of a microprocessor chip.

Prior methodologies for testing on-chip memory arrays include both Built-In-Self-Test (BIST) and Direct Access Testing (DAT). DAT involves porting the memory array I/Os off the chip in order to engage in direct testing of the array, in a manner similar to testing a discrete memory array device. The DAT solution provides the power and flexibility of today's testing equipment but requires more expensive and complex external test support, high-speed I/O for at-speed testing, and additional circuitry and busses than would otherwise be available on the chip in order to properly test and characterize the arrays.

BIST differs from DAT in that it essentially integrates the test vector generation provided by the external tester equipment of DAT on-chip. As a result, a BIST implementation requires less hardware than a DAT implementation. Existing BIST solutions provide either fixed or programmable test vector generation. Prior art DAT and BIST systems are described in more detail in commonly-owned U.S. Pat. No. 6,321,320 B1 to Fleischman et al., entitled “Flexible and Programmable BIST Engine for On-Chip Memory Array Testing and Characterization.”

In general, both BIST and DAT memory monitoring systems monitor and record information related to each memory access, such as the index of the accessed memory location, whether the access was a read or write (signified by the value of a write enable bit), and the data that was read from or written to the memory location (referred to as the cache data).

Conventional on-chip memories may be implemented in a single memory array or using multiple memory arrays, each of which may be divided into multiple sub-arrays. When memory arrays are divided into sub-arrays, it may be desirable to monitor and record the identity of the particular sub-array that is accessed by each memory operation for the same reasons as it may be useful to monitor and record the other information that is normally monitored and recorded by conventional monitoring systems. It is desirable that the addition of mechanisms for monitoring sub-array information be efficient in terms of both size and speed so that they do not interfere with the normal operation of the chip.

What is needed, therefore, are techniques for monitoring sub-array selection in on-chip memories having multiple memory arrays.

### SUMMARY

In one aspect, the invention features an on-chip monitor for monitoring operations performed on an on-chip memory block. In particular, the monitor monitors the sub-array accessed by memory access operations, in addition to other information related to the operation, such as the index of the accessed memory location, the data read from or written to the memory location, and a write enable indicating whether the operation was a read or a write. The monitor circuitry may store monitored data quickly enough to avoid having an impact on normal operation of the memory block. Furthermore, the monitor circuitry may utilize a relatively small number of circuit elements and control signals to enable the monitor to fit within the confines of an on-chip memory. The monitor may include circuitry for reading monitored data in a way that enables the monitored block identifier, index, sub-array identifier, and cache data for each memory operation to be correlated with each other quickly and easily.

For example, one aspect of the present invention is directed to a device in a memory on an integrated circuit including a microprocessor core and a plurality of memory arrays. The device includes: first write enable monitoring means for monitoring a first write enable signal for a first one of the plurality of memory arrays, the first one of the plurality of memory arrays comprising a first plurality of sub-arrays; and first array enable monitoring means for monitoring a first array enable signal that selects a first sub-array from among the first plurality of sub-arrays.

Another aspect of the present invention is directed to a device in a memory on an integrated circuit including a microprocessor core and a plurality of memory arrays. The device includes: (A) a plurality of registers configured as a first-in first-out buffer and comprising: (1) first write enable monitoring means for monitoring a first write enable signal for a first one of the plurality of memory arrays, the first one of the plurality of memory arrays comprising a first plurality of sub-arrays; and (2) first array enable monitoring means for monitoring a first array enable signal that selects a first sub-array from among the first plurality of sub-array; (B) means for determining whether data stored in a first one of the plurality of registers comprises data written to the memory; (C) first reading means for reading data stored in the first-in register in the first-in first-out buffer if it is determined that the data stored in the first one of the plurality of registers comprises data written to the memory; and (D) second means for reading data stored in the first-out register in the first-in first-out buffer if it is determined that the data stored in the first one of the plurality of registers does not comprise data written to the memory.

Yet another aspect of the present invention is directed to a device in a memory on an integrated circuit including a microprocessor core and a plurality of memory arrays. The device includes a register storing at least some of a memory index associated with a previously-performed memory operation; first retrieval means for retrieving fewer than all of the bits of the memory index; second retrieval means for retrieving a first stored array enable bit; and reconstruction means for reconstructing at least some of the bits of the memory index not retrieved by the first retrieval means based on the stored index bit and the first stored array enable bit.

A further aspect of the present invention is directed to a device in a memory on an integrated circuit including a microprocessor core and a plurality of memory arrays. The device includes a register storing all but the most significant bit of a memory index associated with a previously-performed memory operation, wherein the register is one bit narrower than the width of the memory index; first retrieval means for retrieving the third most significant bit of the memory index; second retrieval means for retrieving a first stored array enable bit; third retrieval means for retrieving a second stored array enable bit; and reconstruction means for reconstructing the two most significant bits of the memory index based on the third most significant bit of the memory index and the first and second stored array enable bits.

Other features and advantages of various aspects and embodiments of the present invention will become apparent from the following description and from the claims.

### BRIEF DESCRIPTION OF THE DRAWINGS

FIG. 1 is a schematic diagram of a prior art integrated circuit including a BIST engine;

FIG. 2 is a schematic diagram of an integrated circuit including two BIST engines according to one embodiment of the present invention;

FIG. 3 is a schematic diagram of the internal circuitry of a decoder to one embodiment of the present invention;

FIG. 4 is a schematic diagram of a cache index monitor according to one embodiment of the present invention;

FIG. 5 is a schematic diagram of a cache data monitor according to one embodiment of the present invention; and

FIG. 6 is a schematic diagram of a write enable and array enable monitor according to one embodiment of the present invention.

### DETAILED DESCRIPTION

In one aspect, the invention features an on-chip monitor for monitoring operations performed on an on-chip memory block. In particular, the monitor monitors the sub-array accessed by memory access operations, in addition to other information related to the operation, such as the index of the accessed memory location, the data read from or written to the memory location, and a write enable indicating whether the operation was a read or a write. The monitor circuitry may store monitored data quickly enough to avoid having an impact on normal operation of the memory block. Furthermore, the monitor circuitry may utilize a relatively small number of circuit elements and control signals to enable the monitor to fit within the confines of an on-chip memory. The monitor may include circuitry for reading monitored data in a way that enables the monitored block identifier, index, sub-array identifier, and cache data for each memory operation to be correlated with each other quickly and easily.

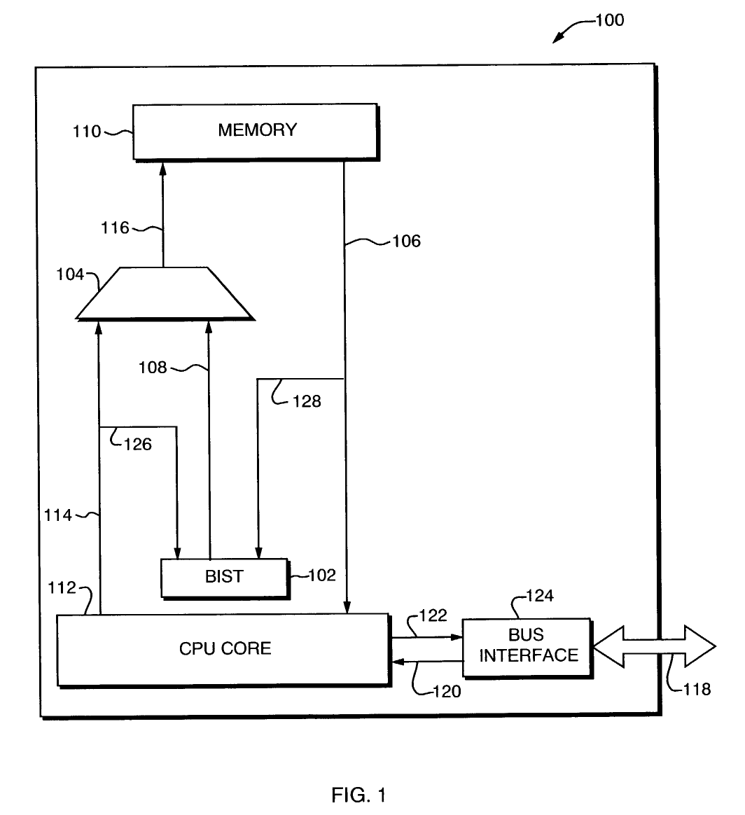

Referring to FIG. 1, a schematic diagram of a prior art integrated circuit 100 is shown including a Built-In Self Test (BIST) engine 102. Multiplexer 104, BIST engine 102, portions of bus 106, and associated address/data bus 108 represent special BIST hardware which has been added to the memory datapath to monitor access to on-chip memory 110. In general, multiplexer 104 selects between write data generated by processor core 112 on address/data bus 114 and write data generated by BIST engine 102 on address/data bus 108. The selected write data is transmitted to memory 110 on bus 116. Data read from memory 110 are transmitted on address/data bus 108.

System bus 118 transmits information to and from off-chip resources. Processor core 112 communicates over system bus 118 through input and output lines 120 and 122 coupled to bus interface 124.

BIST engine 102 uses bus 126 to monitor the address, write data, and write enable information transmitted by CPU core 112 on bus 114. Similarly, BIST engine 102 uses bus 128 to monitor read data read from memory 110 on bus 106. Memory 110 is implemented as a single memory array. BIST engine 102 therefore only includes circuitry for monitoring the address, read/write data, and write enable associated with each memory access.

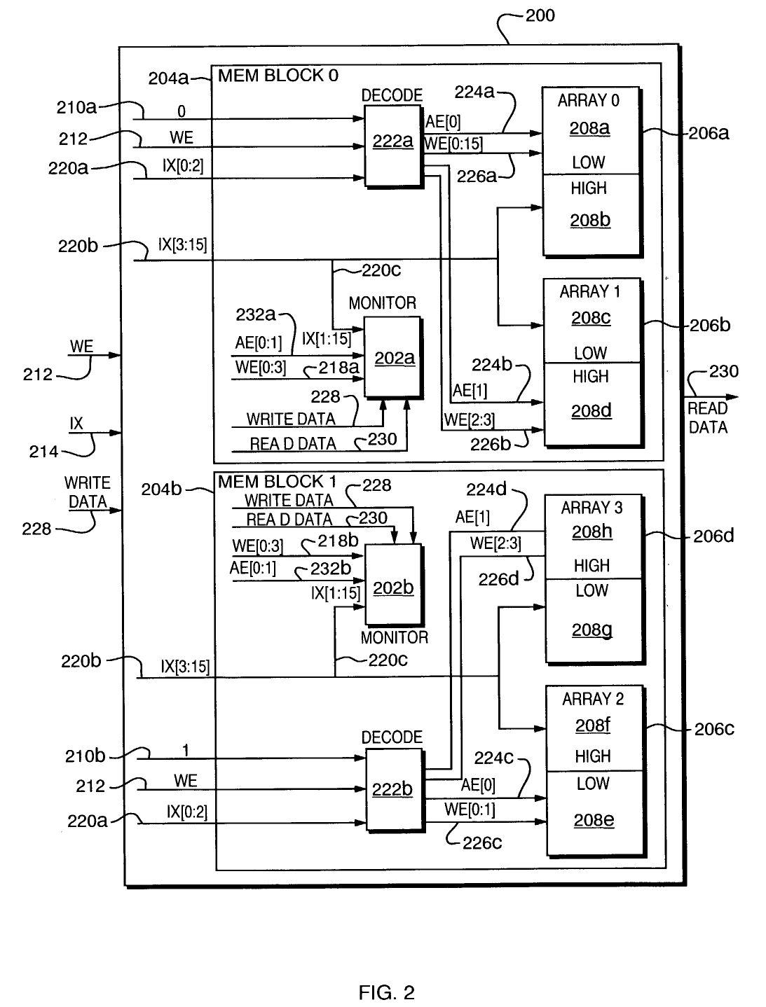

Referring to FIG. 2, a schematic diagram is shown of an on-chip memory 200 including the monitor portion of BIST engines 202a-b according to one embodiment of the present invention. Memory 200 is divided into two memory blocks 204a and 204b. Each of the blocks 204a-b is in turn divided into two arrays. In particular, block 204a is divided into arrays 206a and 206b, while block 204b is divided into arrays 206c and 206d. Each of arrays 206a-d is in turn divided into a low sub-array and a high sub-array. In particular, array 206a is divided into low sub-array 208a and high sub-array 208b, array 206b is divided into low sub-array 208c and high sub-array 208d, array 206c is divided into low sub-array 208e and high sub-array 208f, and array 206d is divided into low sub-array 208g and high sub-array 208h.

Blocks 204a-b, arrays 206a-d, and sub-arrays 208a-h are arranged so that consecutive memory addresses are mapped to memory locations in the order in which sub-arrays 208a-h are numbered in FIG. 1. In other words, memory address are mapped to consecutive memory locations beginning in memory sub-array 208a, followed by memory sub-array 208b, followed by memory sub-array 208c, and so on.

Memory 200 receives three clocked inputs 212, 214, and 228 for each memory access. In particular, write enable input (WE) 212 is a one-bit input that indicates whether the memory access operation to be performed is a read operation or a write operation. A write enable value of zero indicates a read and a value of one indicates a write.

Index input (IX) 214 is a 16-bit input that specifies the index of the memory location to be accessed within the memory 200. In particular, the most significant bit of index 214 specifies one of the two blocks 204a-b, the next bit of index 214 specifies one of the four arrays 206a-d (by specifying an array within the previously-specified block), and the next bit of index 214 specifies one of the eight sub-arrays 208a-h (by specifying a region within the previously-specified array). In the present example, bit zero is the most significant bit (MSB) of the index input 214.

Write data 228 is a single word to be written into the memory location specified by the index 214. Although the write data 228 may have any width, in the present example the write data 228 is a 120-bit word.

Data read from the memory 200 are output as read data 230. In any particular state, data are read from one of the array sub-arrays 208a-h. Outputs from all of the sub-arrays 208a-h are provided to a multiplexer, which uses the three most significant bits of the index 214 to select the appropriate output as the read data 230. In particular, the most significant bit selects the block, the next bit selects the array within the block, and the next bit selects the region within the array. The multiplexer and associated circuitry for providing the read data 230 may be implemented using conventional techniques and therefore are not shown in FIG. 1 for ease of illustration.

Before proceeding, the textual and graphical notations in the following description and drawings will first be explained. Signals, such as the write enable 212 and the index 214, are labeled in the drawings using the abbreviations indicated above (such as WE for the write enable 212 and IX for the index 214). The use of a bare signal name (such as IX) refers to the complete signal. The use of a signal name followed by a single index in brackets (such as IX[2]) refers to a single bit of the signal specified by the index, where an index of zero specifies the most significant bit. The use of a signal name followed by a lower and upper index in brackets (such as IX[3:15]) refers to a sequence of signal bits whose indices range from the specified lower index to the specified upper index.

Furthermore, for ease of illustration and to reduce clutter in the drawings, signal paths are only shown where relevant in the drawings, and sub-signals may be illustrated as being disconnected from the corresponding complete signals. Those of ordinary skill in the art will appreciate that conventional techniques may be used to separate signals into sub-signals and to combine sub-signals into signals to implement the circuitry disclosed herein.

Furthermore, although the write enable 212, index 214, and write data 228 are illustrated in FIG. 1 as being transmitted on single lines, it should be appreciated that in practice these inputs may be transmitted on busses of appropriate widths and may be further combined or separated onto a lesser or greater number of busses than are illustrated in the drawings.

The write enable 212 and the three most significant bits 220a of the index 214 (IX[0:2]) are input into a first decoder 222a in memory block 204a and a second decoder 222b in memory block 204b. A signal 210a hardwired to zero (low) is also input into decoder 222a, indicating that decoder 222a is the decoder for the block having block ID zero (block 204a). Similarly, a signal 210b hardwired to one (high) is input into decoder 222b, indicating that decoder 222b is the decoder for the block having block ID one (block 204b). The purpose of decoders 222a-b is to determine which of the arrays 208a-h is referenced by the combination of block ID and index bits 220a and to generate signals which access the referenced array in the specified manner (i.e., by writing or reading data). The three most significant bits 220a of index 214 specify one of the memory sub-arrays 208a-h, while the thirteen least significant bits 220b of index 214 specify a particular memory location within the specified region.

In particular, each of the decoders 222a-b generates an array enable bit and two write enable bits for each of the two arrays in the corresponding block. More specifically, decoder 222a generates and transmits: (1) a first array enable bit AE[0] 224a of a first two-bit array enable signal, and the two most significant bits WE[0:1] 226a of a four-bit write enable signal to array 206a; and (2) a second array enable bit AE[1] 224b of the first array enable signal and the two least significant bits WE[2:3] 226b of the first four-bit write enable signal to array 206b. Similarly, decoder 222b generates and transmits: (1) a first array enable bit AE[0] 224c of a second two-bit array enable signal, and the two most significant bits WE[0:1] 226c of a second four-bit write enable signal to array 206c; and (2) a second array enable bit AE[1] 224d of the second two-bit array enable signal, and the two least significant bits 226d of the second four-bit write enable signal to array 206d.

As stated above, each of the decoders 222a-b generates a four-bit write enable signal. Each bit of these write enable signals serves as a write enable signal for a corresponding one of the memory regions 208a-d. For example, write enable bits 226a serve as write enable signals for regions 208a and 208b, and write enable bits 226b serve as write enable signals for regions 208c and 208d. A high write enable value indicates a write.

Similarly, each of the array enable signals 224a-d serves as an array enable signal for a corresponding one of the memory arrays 206a-d. A high array enable bit value indicates that the corresponding array is to be enabled (accessed). For example, when array enable bit 224a is high and array enable bit 224b is low, array 206a will be accessed but not array 206b. Similarly, when array enable bit 224c is low and array enable bit 224d is high, array 206d will be accessed but not array 206c.

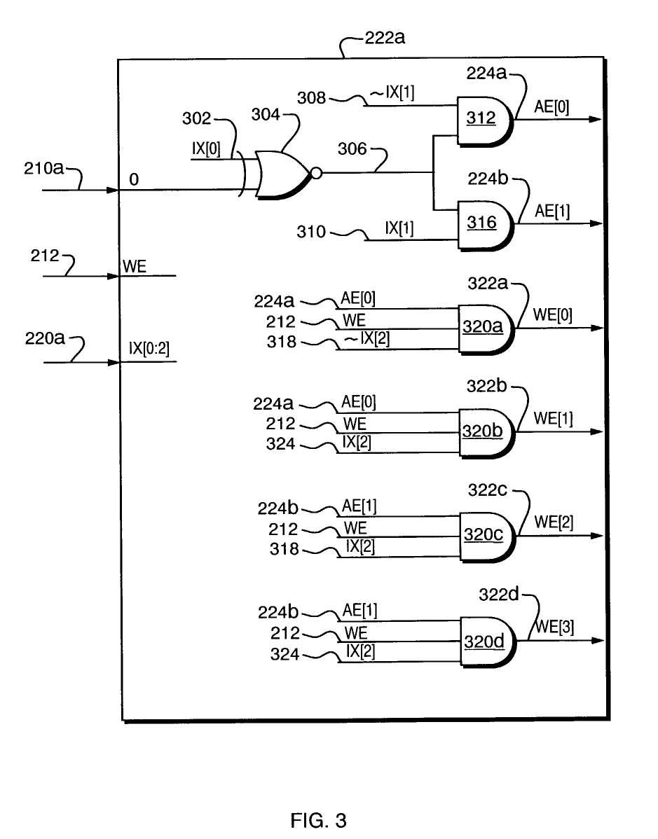

Referring to FIG. 3, a schematic diagram is shown of the internal circuitry of decoder 222a according to one embodiment of the present invention. The decoder 222b may be implemented using the same circuitry.

Decoder 222a receives as inputs the block ID signal 210a hardwired to zero, the write enable 212, and the three most significant bits IX[0:2] 220a of index 214. (Although the circuitry for decoder 222b may be the same as the circuitry illustrated in FIG. 3, the decoder 222b receives the block ID signal 210b hardwired to one rather than zero.) The decoder 222a includes an XNOR gate 304 which receives bit zero 302 of the index 214 and the block ID 210a as inputs. The output 306 of the XNOR gate 304 is high when IX[0] 302 is low and, while the XNOR gate 304 is low when IX[0] is high. The XNOR gate 304 therefore effectively acts as an inverter for IX[0] 302 in decoder 222a.

As described in more detail below, the operation of XNOR gate 304 ensures that array enable bits AE[0] 224a and AE[1] 224b will always be zero when IX[0] 302 is high, reflecting the fact that decoder 222a decodes input for memory block 204a, which includes memory locations having addresses whose most significant bit is equal to zero. The corresponding XNOR gate (not shown) in decoder 222b ensures that the array enable bits 224c-d will always be zero when IX[0] 302 is low.

The decoder 222a generates the two array enable bits 224a and 224b as follows. The decoder 222a includes AND gates 312 and 316. The first AND gate 312 receives as inputs: (1) ˜IX[1] 308 (the inverse of bit one of the index 214), and (2) the output 306 of the NOR gate 304. The signal ˜IX[1] 308 may be generated, for example, by using an inverter (not shown) to invert bit one of the index 214. Other inverse signals illustrated in FIG. 3 may similarly be generated by invertors which are not shown in FIG. 3 for ease of illustration. The second AND gate 316 receives as inputs: (1) the output 306 of the NOR gate 304, and (2) IX[1] 310 (bit one of the index 214).

AND gate 312 produces AE[0] 224a (bit zero of the array enable 232a) by performing a logical AND operation on inputs 308 and 306, while AND gate 316 produces AE[1] 224b (bit one of array enable 232a) by performing a logical AND operation on inputs 306 and 310. AE[0] 224a is high only when IX[0] 302 and IX[1] 310 are low, while AE[1] 224b is high only when IX[0] 302 is low and IX[1] 310 is high. In other words, bit one of the index 214 selects between arrays 206a and 206b when IX[0] 302 is low.

The decoder 222a provides: (1) AE[0] 224a to array 206a, (2) AE[1] 224b to array 206b, and (3) both array enable bits 232a to monitor 202a, as illustrated in FIG. 2. Similarly, the decoder 222b provides AE[0] 224c to array 206c, AE[1] 224d to array 206d, and both array enable bits 232b to monitor 202b, as illustrated in FIG. 2.

The three most significant bits IX[0:2] 220a of index 214 code for the eight sub-arrays 208a-h of memory 200. In particular, the binary value 000 indicates sub-array 208a, 001 indicates sub-array 208b, 010 indicates sub-array 208c, 011 indicates sub-array 208d, and so on.

Decoder 222a generates individual bits 322a-d of write enables 226a-b using four AND gates 320a-d as follows. In particular, AND gate 320a receives as inputs AE[0] 224a (bit zero of the array enable 232a), the write enable 212, and ˜IX[2] 318 (the inverse of bit two of the index 214). AND gate 320a produces WE[0] 322a (write enable bit zero) by performing a logical AND on its three inputs 224a, 212, and 318. WE[0] 322a should be high only when a write operation is to be performed in low sub-array 208a of array 206a. The AND gate 320a accomplishes this by making WE[0] 322a high only when a write operation is selected (i.e., when the write enable 212 is high), array 206a is selected (i.e., when AE[0] 224a is high), and when bit two of index 214 is low (i.e., when ˜IX[2] 318 is high).

AND gate 320b receives as inputs AE[0] 224a, write enable 212, and IX[2] 324. AND gate 320a produces WE[1] 322b (write enable bit one) by performing a logical AND on its three inputs 224a, 212, and 324. WE[1] 322b should be high only when a write operation is to be performed in high sub-array 208b of array 206a. The AND gate 320b accomplishes this by making WE[1] 322b high only when a write operation is selected (i.e., when the write enable 212 is high), array 206a is selected (i.e., when AE[0] 224a is high), and when bit two of index 214 is high.

AND gate 320c receives as inputs AE[1] 224b, write enable 212, and ˜IX[2] 318. AND gate 320a produces WE[2] 322c (write enable bit two) by performing a logical AND on its three inputs 224b, 212, and 318. WE[2] 322c should be high only when a write operation is to be performed in low sub-array 208c of array 206b. The AND gate 320c accomplishes this by making WE[2] 322c high only when a write operation is selected (i.e., when the write enable 212 is high), array 206b is selected (i.e., when AE[1] 224b is high), and when bit two of index 214 is low.

AND gate 320d receives as inputs AE[1] 224b, write enable 212, and IX[2] 324. AND gate 320a produces WE[3] 322d (write enable bit three) by performing a logical AND on its three inputs 224b, 212, and 324. WE[3] 322d should be high only when a write operation is to be performed in high sub-array 208d of array 206b. The AND gate 320d accomplishes this by making WE[3] 322d high only when a write operation is selected (i.e., when the write enable 212 is high), array 206b is selected (i.e., when AE[1] 224b is high), and when bit two of index 214 is high.

The decoder 222a provides write enable bits 322a-d to arrays 206a-b and monitor 202a as illustrated in FIG. 1. In particular, decoder 222a provides write enable bits zero and one 226a to array zero, and provides write enable bits two and three 226b to array one. Furthermore, decoder 222a provides all four write enable bits to monitor 202a as a first four-bit write enable signal 218a. Similarly, decoder 222b provides write enable bits zero and one 226c to array 206c, provides write enable bits two and three 226d to array 206d, and provides all four write enable bits 218d to monitor 202b as a second four-bit write enable signal 218b.

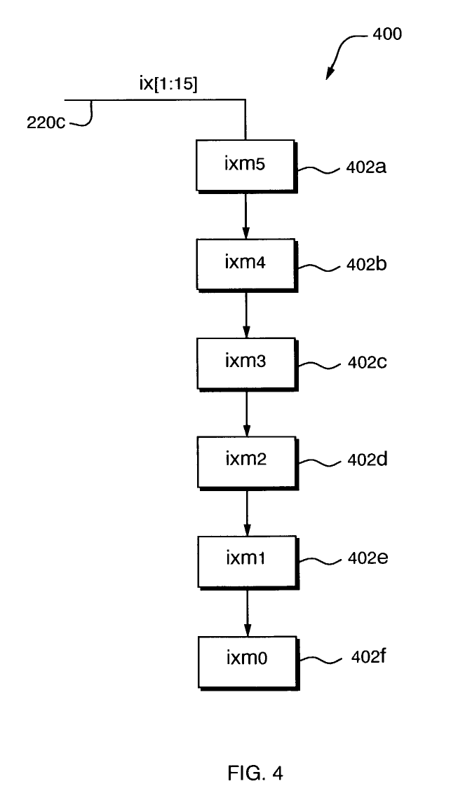

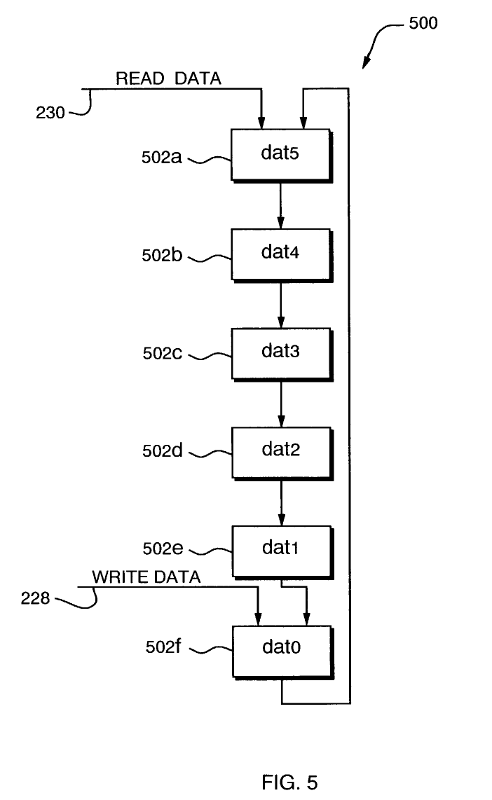

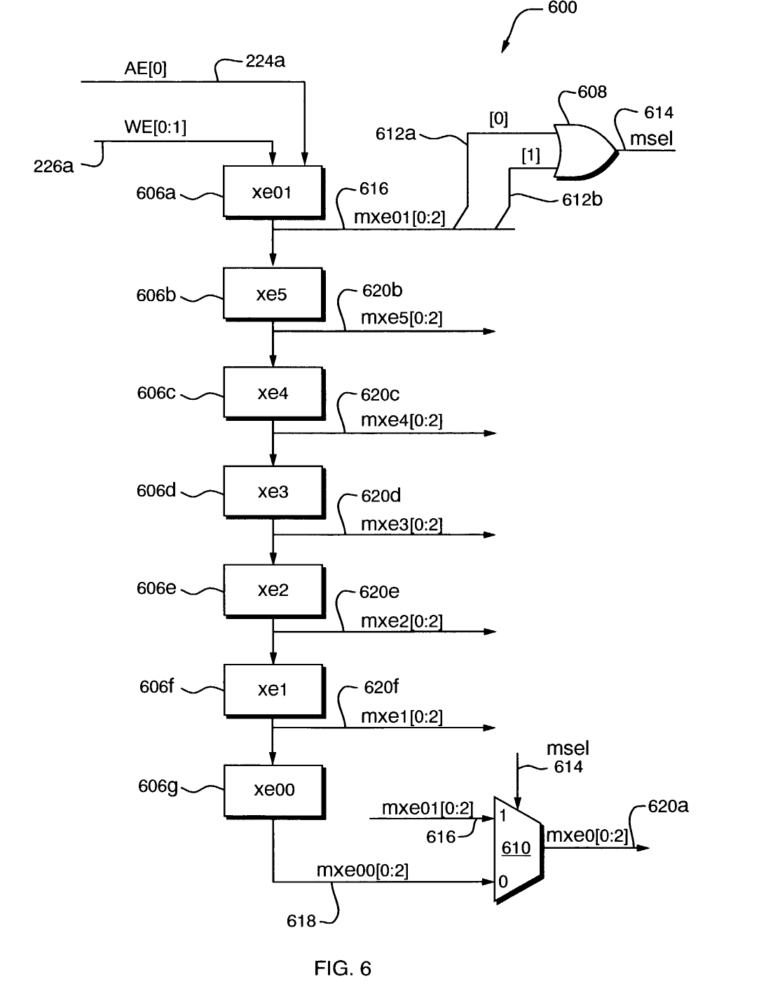

Referring to FIGS. 4-6, particular embodiments of portions of the monitor 202a for monitoring the cache index 214 (FIG. 4), cache write data 228 and read data 230 (FIG. 5), and cache write enable 218a and array enable 232a (FIG. 6) are shown. It should be appreciated that the same or similar circuitry may be used to implement the monitor 202b.

Referring to FIG. 4, a cache index monitor 400 is shown in block diagram form according to one embodiment of the present invention. The cache index monitor 400 may be implemented as a component of the monitor 202a. In the particular embodiment illustrated in FIG. 4, the cache index monitor 400 receives as an input the fifteen least-significant bits 220c of the index 214. The cache index monitor 400 may, however, monitor all bits of the index 214 or fewer than fifteen bits of the index 214.

The cache index monitor 400 includes six registers 402a-f which function as a First-In First-Out (FIFO) buffer. Each of the registers 402a-f is of a suitable width, such as 15 bits, for storing the index bits 220c. On every state, each of the registers 402a-f loads the value from the register above it, and register 402a loads the current value of the index bits 220c. The index bits that were previously stored in register 402f are discarded.

This FIFO behavior continues indefinitely until some event (such as a parity error) occurs which triggers a FIFO freeze. Upon the occurrence of such a freeze, the registers 402a-f provide a history of the indices of the six most recently accessed locations in the memory block 204a. The information stored in the registers 402a-f may be used to debug failures and to perform memory self repair.

Referring to FIG. 5, a cache data monitor 500 is shown in block diagram form according to one embodiment of the present invention. The cache data monitor 500 may be implemented as a component of the monitor 202a. The cache index monitor 500 receives as inputs and monitors both the cache write data 228 and the cache read data 230.

Like the cache index monitor 400, the cache data monitor 500 includes six registers 502a-f which function as a FIFO buffer. Each of the registers 502a-f is of a suitable width, such as 120 bits, for holding the cache read data 230 and cache write data 228. On each state, a single memory access operation is performed on the memory block 204a. The memory access operation may be either a read or write operation, but not both. The single stack of registers 500 may therefore be used to hold the data that are read from or written to the memory block 204a in six consecutive memory accesses, rather than utilizing distinct stacks of registers for read and write operations.

On every state, each of the registers 402a-f loads the value from the register above it. If the current memory operation is a write operation, the write data 228 enters at the bottom and is stored in register 502f, thereby overwriting the value previously stored in register 502e. On the next state, the data stored in register 502f loops back to the top of the stack of registers 502a-f. Read data 230, in contrast, enters at the top and is stored in register 502a, and then moves downward through the stack of registers 502a-f.

The read data 230 and write data 228 are initially stored in different registers in this manner because write data 228 is made available to the monitor 500 during the same state in which the write data is written to memory block 204a, while read data 230 only becomes available in the next state after the corresponding read request is made. Initially storing the read data 230 and write data 228 in registers 502a and 502f, respectively, as described above with respect to FIG. 5, ensures that the values stored in the registers 502a-f at any particular point in time accurately reflect the values read from and/or written to the memory block 204a in the six most recent memory access operations.

Referring to FIG. 6, a cache write enable and array enable monitor 600 is shown in block diagram form according to one embodiment of the present invention. The monitor 600 may be implemented as a component of the monitor 202a. The monitor 600 receives as inputs and monitors both the write enable bits WE[0:1] 226a and the array enable bit AE[0] 224a. Although only one write enable and array enable monitor 600 is shown in FIG. 6, a second monitor identical to the monitor 600 may be included in the monitor 202a for monitoring the write enable bits WE[2:3] and the array enable bit AE[1].

Like the cache index monitor 400 and the cache data monitor 500, the cache write enable and array enable monitor 600 includes seven registers 606a-g which function as a FIFO buffer. Each of the registers 606a-g is of a suitable width, such as 3 bits, for holding both the write enable bits 226a and array enable bit 224a. In the present example, the two most significant bits of each of the registers 606a-g store write enable data, while the least significant bit of the registers 606a-g stores array enable data.

In the present embodiment, the write enable 602 and array enable 604 bits are stored in the registers 606a-g in such a way that each of the registers 606a-g stores information relating to the same memory access operation as the corresponding ones of the cache data registers 502a-f (FIG. 5) and the cache index registers 402a-f (FIG. 4). For example, at any particular point in time register 606b contains the write enable bits and array enable bit for the memory access operation which accessed the memory location in block 204a indexed by the index stored in register 402a (FIG. 4) to read/write the data stored in register 502a (FIG. 5). Similarly, at any particular point in time register 606c contains the write enable bits and array enable bit for the memory access operation which accessed the memory location in block 204a indexed by the index stored in register 402b (FIG. 4) to read/write the data stored in register 502b (FIG. 5). As a result, all of the monitored information for a particular memory access operation—index, cache data, write enable, and array enable—may be easily correlated and retrieved when needed.

In particular, the write enable bits 226a and the array enable bit 224a enter at the top of the stack of registers 606a-g, are stored in register 606a, and move through the stack of registers 606a-g in FIFO fashion. No determination need be made as to whether the operation being monitored is a read operation or a write operation at the time information is stored in the registers 606a-g. Rather, that decision may be deferred until the stack of registers 606a-g is frozen and the contents of the registers 606a-g are read.

The contents of all of the registers 606a-g except for registers 606a and 606g may be read straightforwardly. When the registers 606a-g are frozen, one of the two registers 606a and 606g contains the write enable and array enable data corresponding to the cache data stored in register 502f (FIG. 5). In particular, if the most-recently performed memory access operation was a write operation, then register 606a contains the write enable and array enable bits corresponding to the cache data stored in register 502f. If, however, the most recently-performed memory access operation was a read operation, then register 606g contains the write enable and array enable bits corresponding to the cache data stored in register 502f.

To ensure that the write enable and array enable bits for the most recently-performed memory access operation are read from the correct one of the registers 606a and 606g, the monitor 600 includes an OR gate 608 and a multiplexer 610. Recall that in each of the 3-bit registers 606a-g, the two most-significant bits store the write enable and the least-significant bit stores the array enable. OR gate 608 takes as inputs the two write enable bits 612a-b stored in the register 606a and performs a logical OR on them to produce a selection signal 614. The selection signal 614 is high if either of the write enable bits 612a-b is high, i.e., if either of the write enable bits 612a-b indicates a write operation. If the selection signal 614 is high, the most recently-performed memory operation was a write operation. Otherwise, the most recently-performed memory operation was a read operation.

The multiplexer 610 takes as data inputs: (1) the contents 616 of register 606a, and (2) the contents 618 of register 606g. The selection signal 614 is provided as the selection input to multiplexer 610, so that the output 620a of multiplexer 610 is selected from inputs 616 and 618 based on the value of the selection signal 614. As a result, the contents of register 606a are provided as the output 620a if the selection signal 610 is low, while the contents of register 606g are provided as the output 620a if the selection signal 610 is high. Therefore, the write enable and array enable bits associated with the cache data stored in register 502f (FIG. 5) are provided as output 620a, regardless of whether that cache data represents read data or write data.

The value of output 620a, which represents the write enable and array enable bits associated with the most recently-performed memory access operation, corresponds to the values stored in the cache index register 402a and the cache data register 502a. Similarly, the values of output 620b, cache index register 402b, and cache data register 502b correspond to the next most-recently performed memory access operation, and so on. The mechanism employed by monitor 600 therefore provides six outputs 620a-f having a sequence which corresponds to the sequence of the cache index registers 402a-f and the cache data monitor registers 502a-f, thereby simplifying the process of reading all of the monitored information corresponding to a particular memory access operation from the monitors 400, 500, and 600.

When data for a particular memory access operation are read from the monitors 400, 500, and 600, the array and region that were accessed by the operation may be identified by reference to bit two of the monitored index (IX[2]) and to both of the monitored array enable bits AE[0:1]. In the absence of the array enable bits AE[0:1], the index bit IX[2] would be ambiguous because it could refer to a memory location in either array 206a or 206b. In particular, the index bit IX[2] and the array enable bits AE[0:1] may be used to identify the accessed array region using a lookup in Table 1:

TABLE 1

| | | | Memory | Array |
|---|---|---|---|---|
| IX [2] | AE [0] | AE [1] | Block | Region |
| 0 | 1 | 0 | 204a | 208a |
| 1 | 1 | 0 | 204a | 208b |
| 0 | 0 | 1 | 204a | 208c |
| 1 | 0 | 1 | 204a | 208d |
| X | 0 | 0 | | |
| 0 | 1 | 0 | 204b | 208e |
| 1 | 1 | 0 | 204b | 208f |
| 0 | 0 | 1 | 204b | 208g |
| 1 | 0 | 1 | 204b | 208h |
| X | 0 | 0 | | |

The first five rows of Table 1 represent information stored in monitor 202a and information derived therefrom. The second rive rows of Table 1 represent information stored in monitor 202b and information derived therefrom.

Considering first the first five rows of Table 1, it may be seen that the values of the array enable bits AE[0] and AE[1] specify one of the two arrays 206a-b and that the value of the index bit IX[2] specifies a region within the specified array. In particular, a value of one for array enable bit AE[0] specifies array 206a while a value of one for array enable bit AE[1] specifies array 206b. Array enable bits AE[0] and AE[1] may not both be equal to one at the same time. If both array enable bits AE[0] and AE[1] are equal to zero for a particular memory access operation, the memory access operation accessed memory block 204b and the values stored in the monitor 202a for the memory operation may be ignored.

Consider, for example, the first row of Table 1. The value of array enable bit AE[0] is one, thereby specifying array 206a, as indicated by the value in the column labeled “Memory Block.” The value of index bit IX[2] is zero, thereby specifying the low sub-array 208a of array 206a, as specified by the column labeled “Array Region.”

Consider now the second row of Table 1, in which the values of the array enable bits AE[0] and AE[1] are the same as in the first row, thereby specifying array 206a. The value of the index bit field IX[2], however, is one, thereby specifying the high sub-array 208b of array 206a, as specified by the “Array Region” column. The meaning of the values of rows three, four, and five should be apparent based on the description just provided. Rows five through ten parallel rows one through five, except that they correspond to the monitor 202b and therefore to memory block 204b rather than 204a.

Among the advantages of the invention are one or more of the following.

Embodiments of the present invention enable all information necessary to identify the index, cache data, write enable, and array associated with a memory access operation to be monitored, recorded, and retrieved quickly and efficiently. For example, referring to FIG. 6, the cache write enable and array enable bits (FIG. 6) may be stored directly in registers and therefore relatively quickly, without the need to determine whether the operation is a read or write operation at the time of monitoring. Making such a determination at the time of monitoring could make the monitoring process too slow to be feasible. It is essential that monitoring not interfere with the normal operation of the memory 200 or processor more generally, so the speed with which the monitors 202a-b are capable of storing information is particularly advantageous. Furthermore, the monitors 202a-b employ relatively little circuitry, thereby making it possible to implement the monitors 202a-b without appreciably increasing the area or power requirements of the memory 200.

Another advantage of embodiments of the present invention is that both read- and write-related data may be easily stored in and retrieved from the monitors 202a-b. In particular, by storing read data 230 in register 502a of cache data monitor 500 (FIG. 5), storing write data 228 in register 502f, and wrapping around the contents of register 502f to register 502 on each state, the single stack of registers 502a-f may be used to store read and write data from the six most recently-performed memory access operations in the correct sequence. Such read and write data may then be read out from the registers 502a-f straightforwardly when needed.

The write enable and array enable monitor 600 (FIG. 6) achieves similar advantages by employing the OR gate 608 and multiplexer 610. As described above, the monitor 600 employs these elements, in conjunction with the particular arrangement of registers 606a-g, to enable write enable and array enable information to be stored quickly and directly in registers 606a-g and to be retrieved quickly from registers 606a-g with relatively little circuitry and few control signals in a manner which ensures that the outputs 620a-f represent the write enable and array enable information for the six most recently-performed memory access operations in the correct sequence.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further divided into additional components or joined together to form fewer components for performing the same functions.

The number of elements illustrated in FIGS. 2-6 are merely illustrative and do not constitute limitations of the present invention. The same techniques may, for example, be applied to different numbers of memory blocks, arrays, index registers, data registers, and write enable and array enable registers. Furthermore, the widths of various words (such as the index 214, write data 228, and read data 230) and of various busses are provided merely for purposes of example and do not constitute limitations of the present invention.

What is claimed is:

1. In a memory on an integrated circuit including a microprocessor core and a plurality of memory arrays, a device comprising:
first write enable monitoring means for monitoring a first write enable signal for a first one of the plurality of memory arrays, the first one of the plurality of memory arrays comprising a first plurality of sub-arrays; and
first array enable monitoring means for monitoring a first array enable signal that selects a first sub-array from among the first plurality of sub-arrays.

2. The device of claim 1, wherein the first write enable monitoring means and the first array enable monitoring means comprise a plurality of registers configured as a first-in first-out buffer.

3. The device of claim 1, wherein the first write enable monitoring means comprises:
write enable recording means for sequentially recording the first write enable signal during each of a plurality of discrete time intervals as a plurality of recorded write enable signals; and
write enable reading means for reading the plurality of recorded write enable signals in the sequence in which they were recorded; and
wherein the first array enable monitoring means comprises:
array enable recording means for sequentially recording the first array enable signal during each of the plurality of discrete time intervals as a plurality of recorded array enable signals; and
array enable reading means for reading the plurality of recorded write enable signals in the sequence in which they were recorded.

4. The device of claim 3, wherein the write enable reading means and the array enable reading means comprise:
means for determining whether data stored in a first one of the plurality of registers comprises data written to the memory;
first reading means for reading data stored in the first one of the plurality of registers if it is determined that the data stored in the first one of the plurality of registers comprises data written to the memory; and
second means for reading data stored in a second one of the plurality of registers if it is determined that the data stored in the first one of the plurality of registers does not comprise data written to the memory.

5. The device of claim 4, wherein the first one of the plurality of registers comprises the first-in register in the first-in first-out buffer, and wherein the second one of the plurality of registers comprises the first-out register in the first-in first-out buffer.

6. The device of claim 4, wherein the means for determining comprises a logic gate having as an input individual bits of the write enable signal stored in the first-in register in the first-in first-out buffer.

7. The device of claim 6, wherein the logic gate comprises a two-input OR gate, and wherein the write enable signal stored in the first-in register comprises a two-bit signal.

8. The device of claim 6, wherein the logic gate includes an output for producing a selection signal that is high only if the write enable signal specifies a write operation, and wherein the first and second reading means comprise a multiplexer comprising two data inputs coupled to the first and second ones of the plurality of registers, respectively, and wherein the multiplexer further comprises a selection input coupled to the output of the logic gate to receive the selection signal.

9. The device of claim 2, wherein the first write enable monitoring means and first array enable monitoring means comprise means for contemporaneously storing data associated with at most a number n of discrete time intervals, and wherein the number of registers in the plurality of registers is greater than n.

10. The device of claim 9, wherein the number of registers in the plurality of registers is equal to n+1.

11. The device of claim 1, further comprising:
second write enable monitoring means for monitoring a second write enable signal for a second one of the plurality of memory arrays, the second one of the plurality of memory arrays comprising a second plurality of sub-arrays; and
second array enable monitoring means for monitoring a second array enable signal that selects a second sub-array from among the second plurality of sub-arrays.

12. The device of claim 1, further comprising:
means for monitoring an index signal specifying an index into the memory.

13. The device of claim 1, further comprising:
means for monitoring data written to the memory; and
means for monitoring data read from the memory.

14. In a memory on an integrated circuit including a microprocessor core and a plurality of memory arrays, a device comprising:
a plurality of registers configured as a first-in first-out buffer and comprising:
first write enable monitoring means for monitoring a first write enable signal for a first one of the plurality of memory arrays, the first one of the plurality of memory arrays comprising a first plurality of sub-arrays; and
first array enable monitoring means for monitoring a first array enable signal that selects a first sub-array from among the first plurality of sub-arrays;
means for determining whether data stored in a first one of the plurality of registers comprises data written to the memory;
first reading means for reading data stored in the first-in register in the first-in first-out buffer if it is determined that the data stored in the first one of the plurality of registers comprises data written to the memory; and
second means for reading data stored in the first-out register in the first-in first-out buffer if it is determined that the data stored in the first one of the plurality of registers does not comprise data written to the memory.

15. The device of claim 14, wherein the means for determining comprises an OR gate having as an input individual bits of the write enable signal stored in the first-in register in the first-in first-out buffer, and wherein the OR gate includes an output for producing a selection signal that is high only if the write enable signal specifies a write operation, and wherein the first and second reading means comprise a multiplexer comprising two data inputs coupled to the first and second ones of the plurality of registers, respectively, and wherein the multiplexer further comprises a selection input coupled to the output of the OR gate to receive the selection signal.

16. The device of claim 14, wherein the first write enable monitoring means and first array enable monitoring means comprise means for contemporaneously storing data associated with at most a number n of discrete time intervals, and wherein the number of registers in the plurality of registers is equal to n+1.

17. In a memory on an integrated circuit including a microprocessor core and a plurality of memory arrays, a device comprising:
a register storing at least some of a memory index associated with a previously-performed memory operation;
first retrieval means for retrieving fewer than all of the bits of the memory index;
second retrieval means for retrieving a first stored array enable bit; and
reconstruction means for reconstructing at least some of the bits of the memory index not retrieved by the first retrieval means based on the stored index bit and the first stored array enable bit.

18. The device of claim 17, wherein the register stores fewer than all of the bits in the memory index.

19. The device of claim 18, wherein the register stores all but the most significant bit of the memory index.

20. The device of claim 18, wherein the width of the register is narrower than the width of the index.

21. The device of claim 20, wherein the width of the register is one bit narrower than the width of the index.

22. The device of claim 17, wherein the first retrieval means comprises means for retrieving a single one of the bits of the memory index.

23. The device of claim 22, wherein the first retrieval means comprises means for retrieving the third most significant bit of the memory index.

24. The device of claim 23, wherein the reconstruction means comprises means for reconstructing the two most significant bits of the memory index.

25. The device of claim 17, further comprising third retrieval means for retrieving a second stored array enable bit; and
wherein the reconstruction means comprises means for reconstructing at least some of the bits of the memory index not retrieved by the first retrieval means based on the stored index bit and the first and second stored array enable bits.

26. In a memory on an integrated circuit including a microprocessor core and a plurality of memory arrays, a device comprising:
a register storing all but the most significant bit of a memory index associated with a previously-performed memory operation, wherein the register is one bit narrower than the width of the memory index;
first retrieval means for retrieving the third most significant bit of the memory index;
second retrieval means for retrieving a first stored array enable bit;
third retrieval means for retrieving a second stored array enable bit; and
reconstruction means for reconstructing the two most significant bits of the memory index based on the third most significant bit of the memory index and the first and second stored array enable bits.
